(19) United States
(12) Patent Application Publication
(10) Pub. No.: US 2021/0158420 A1
(43) Pub. Date: May 27, 2021

(54) CLUSTERED USER BROWSING MISSIONS FOR PRODUCTS WITH USER-SELECTABLE OPTIONS ASSOCIATED WITH THE PRODUCTS

(71) Applicant: Amazon Technologies, Inc., Seattle, WA (US)

(72) Inventors: Brett Patrick Canfield, Seattle, WA (US); Jean Joseph Tavernier, Seattle, WA (US)

(73) Assignee: Amazon Technologies, Inc., Seattle, WA (US)

(21) Appl. No.: 16/694,697

(22) Filed: Nov. 25, 2019

(51) Int. Cl. G06Q 30/06; G06F 16/953

(52) U.S. Cl. CPC G06Q 30/0629; G06Q 30/0643; G06F 16/953

(57) ABSTRACT

A user interface (UI) feature assists users in comparing items and making purchase decisions. One or more shopping missions are identified and consolidated so that a user easily compares competing vendors for previously viewed products. Additionally, user-selectable product options (e.g., size, color, etc.) are automatically pre-selected based upon past online shopping behavior and the availability of such options are displayed in the comparison so that the user makes meaningful shopping decisions and leverage past shopping results.

### BACKGROUND

In online shopping, customers start anew each time they enter a website, unless they have items stored in an electronic shopping cart. Additionally, customers have difficulty comparing products while online shopping. The shopping cart does little in assisting the customers in performing a product comparison. Thus, the overall online shopping experience is inefficient and puts an unnecessary burden on the customer.

### BRIEF DESCRIPTION OF THE DRAWINGS

FIG. 1 shows a user interface (UI) with a main home-page pane and an optional mission-based pane that displays previous searches together with user selectable product options preselected based on past user behavior.

FIG. 2 shows a mission-based pane including 2 different missions with a plurality of products illustrated within each mission.

FIG. 3 shows an additional mission-based pane that is illustrated when a particular mission is selected from FIG. 2.

FIG. 4 is an example system diagram for implementing the UI described herein.

FIG. 5 is an example diagram showing further details of the system of FIG. 4.

FIG. 6 shows an example of different clusters of products searched and data stored in association with those searches.

FIG. 7 shows an example of user selectable product options for a product.

FIG. 8 is a flowchart according to one embodiment for displaying a user online shopping mission.

FIG. 9 is a flowchart according to another embodiment for displaying a user online shopping mission.

FIG. 10 depicts a generalized example of a suitable computing environment in which the described innovations are be implemented.

FIG. 11 is a system diagram according to one embodiment for displaying selectable product options in association with clusters of products.

### DETAILED DESCRIPTION

Displaying past searches of a user for comparison results in user frustration when insights into user-selectable product options are not displayed. For example, displaying products to a user without any insights into user sizing frustrates a user that selects the product only to find that it is not available in the desired size.

A user interface (UI) feature, as disclosed herein, assists users in comparing items and making purchase decisions. One or more shopping missions are identified and consolidated so that a user easily compares competing vendors for previously viewed products. Additionally, user-selectable product options (e.g., size, color, etc.) are automatically pre-selected based upon past online shopping behavior and the availability of such options is displayed in the comparison so that the user makes meaningful shopping decisions.

A shopping mission module first identifies a user mission based upon their shopping actions. The module then automatically builds a comparison set of the products that the user has viewed that are within the identified mission. A user behavior module is used to determine particular user-selectable product options that the user is interested in and highlights the options of each item that fulfills the user's inferred decision criteria. Items that do not satisfy the user's options are also be displayed. For example, if a user is on a mission for “black running shoes in size 10”, the UI highlights each pair considered whether the shoes meet the criteria of “black” and/or “size 10”. Various parameters are used to determine the user intent including past searches, click history, and purchases.

The UI feature described herein is accessible for users via an overlay that slides in from an edge of the screen. In some embodiments, no new page load is needed, leaving the user's current page and place within the browser as is, but providing an additional viewing pane of the browser. Users collapse the view of their current shopping mission and/or scroll down to view comparison sets of other missions not yet completed. If no active mission is identified, the default view is to display the most recent, incomplete shopping missions and the top identified products in the comparison set for each. By storing mission progress, users retain their consideration sets for incomplete missions, even if they close the application to return at a later date.

The UI also provides aspects of the product detail pages such as pricing details, or configuration availability related to the mission's decision criteria. Thus, attributes of the detail pages of a product that a user previously showed interest in are illustrated to aid the user in shopping decisions.

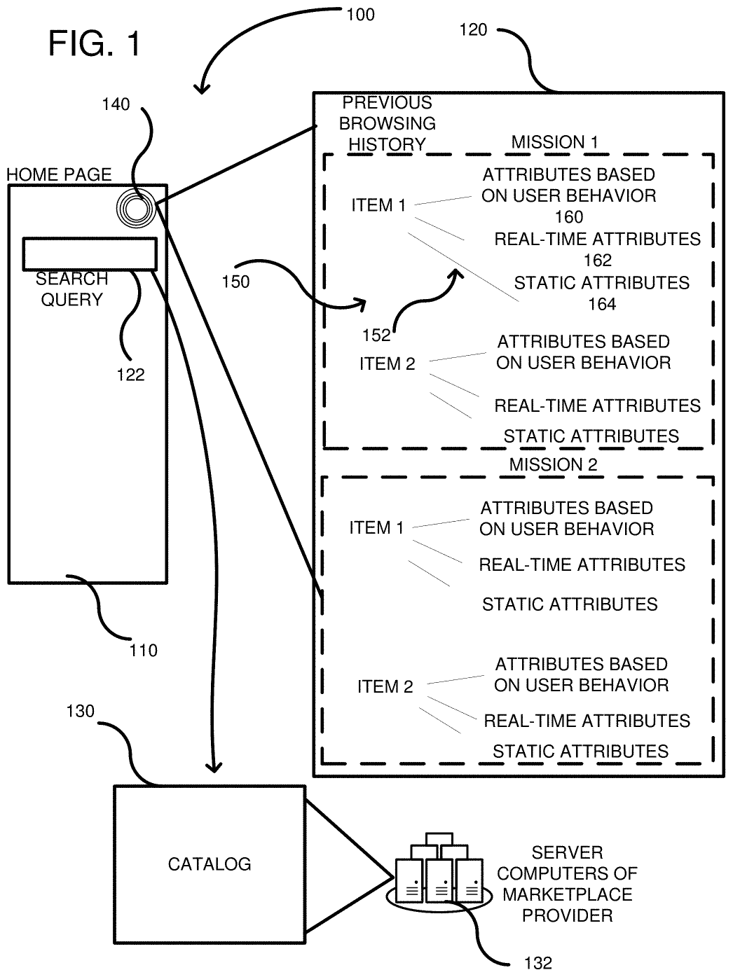

FIG. 1 shows a user interface 100 including a home page in a first viewing pane 110 and a mission page in a second viewing pane 120. Both the first viewing pane 110 and second viewing pane 120 are a UI for a same browser application but can be within a single integrated viewing pane. A search query box 122 is used by a user to enter search queries for searching a product catalog 130 of a marketplace provider hosted by one or more server computers 132. The catalog 130 includes a variety of products for purchase by users through the home page 110. The home page 110 has a UI element 140, which, in this case, is a bullseye symbol, that when selected brings up the second viewing pane 120. The second viewing pane 120 includes information about previous browsing history of the user. In particular, previous search results are grouped into missions, which in this case are shown as mission 1 and mission 2. Additional missions are shown. Mission 1 is shown having numerous items 150 that are products from previous searches. Additionally, attributes associated with items 150 are shown generally at 152. The attributes 152 include attributes based on user behavior 160, real-time attributes 162 and static attributes 164. The attributes based on user behavior 160 include previous search queries, click patterns, past purchase behavior and explicit preferences supplied by the user. As described more fully below, the search queries are processed with a natural language processor (NLP) to extract the attributes displayed in association with missions. For example, a previous search on “running shoes size 8” can be parsed by an NLP to extract “size 8” as a future attribute to display in missions. Thus, in such a case, the attribute 160 is “size 8”. The attributes based on user behavior 160 are on sub-pages (also called “detail pages”) associated with the product, wherein the user needs to select one option from amongst a plurality. The real-time attributes 162 are attributes that the marketplace provider calculates dynamically and changes frequently. For example, shipping costs and delivery times (1 day, 2 day, etc.) changes multiple times per day and are obtained in real time once a request is received to view the second viewing pane 120 (i.e., UI element 140 is selected). The static attributes 164 includes parameters that do not change frequently, such as the seller of the item, the star rating (which can change once a day or week,) etc. Each item in the mission has different attributes displayed so that the user easily compares items displayed in the mission available from different vendors and also sees user-selectable options that the user cares about based on shopping history. Thus, a mission is a grouping of related products for which a user previously searched.

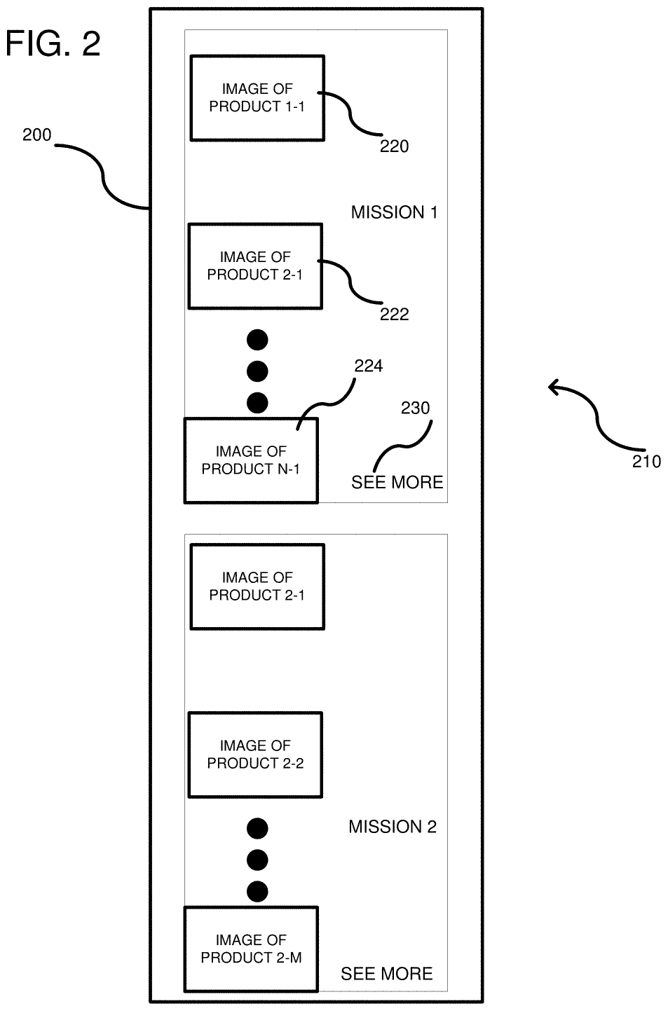

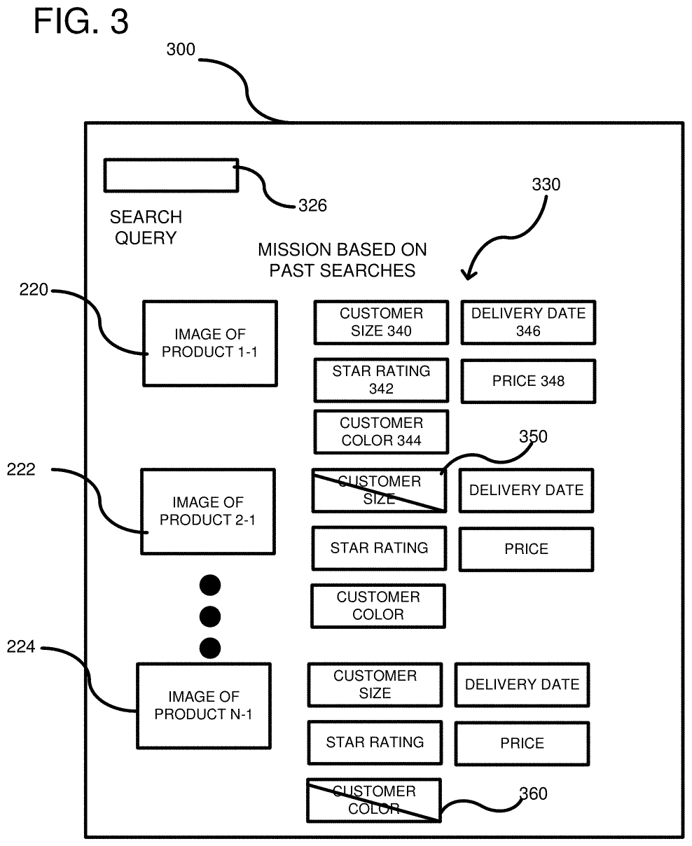

FIG. 2 is another example pane 200 that is displayed including one or more missions, shown generally at 210, together with images of products displayed in each mission. Pane 200 is a replacement for pane 120. For example, image 220 is of a product in a category, while images 222, 224 are other images of similar products in the same category as image 220. The products are the same product supplied by different vendors or similar products. As indicated by image 224, there are N products shown, wherein N is any integer number. In the embodiment shown, each mission has a “see more” icon, such as is shown at 230, so that the user indicates the mission of interest. Thus, the pane 200 allows a user to view a high-level of various missions of interest, wherein the missions represent similar products from the catalog grouped together for comparison. When the user selects the icon 230, an example result of the selection is shown in FIG. 3.

FIG. 3 shows an example pane 300 corresponding to mission 1 of FIG. 2. The different product images 220, 222, 224 are images of previous search results for searches performed by the user. A search query box 326 allows the user to enter a new search term so as to add more products to the mission or further refine the mission. Each product has associated attributes therewith. For example, product 220 has a plurality of attributes shown generally at 330 including a user size attribute 340, a star rating attribute 342, a user color attribute 344, a delivery schedule attribute 346, and a price attribute 348. Although the attributes are shown generically, actual values are displayed for the attributes based on information obtained from the marketplace provider (shown at 132, FIG. 1). For example, the user size 340 displays a size, such as 8, the price 348 is a specific price, such as $32, the user color 344 is a particular color, such as red, etc. As described further below, the user size 340 and the user color 344 are user selectable product options that are obtained by the marketplace provider from previous search data. For example, if the user previously selected size 8, then the attributes 330 are pre-populated to what the user had selected on previous searches or purchases. Thus, previous user behavior is used to determine what the user would be interested in seeing in pane 300. Additionally, the displayed product options change based upon the past user browsing behavior. Thus, if the user changes a size to an 8.5, then the size attribute 340 also changes. As shown at 350, if the user size (inferred from previous user behavior (hereinafter the “inferred” size)) is not available, then an indication is shown with a slash through the size to indicate the user's inferred size is not currently available from the vendor 222. Likewise, as shown at 360, the user's color (inferred from previous user behavior (hereinafter the “inferred” color)) is not available from vendor 224. Thus, the user makes a quick comparison between the products offered from different vendors and attributes associated with the products including attributes derived from selections that the user made during earlier browsing searches.

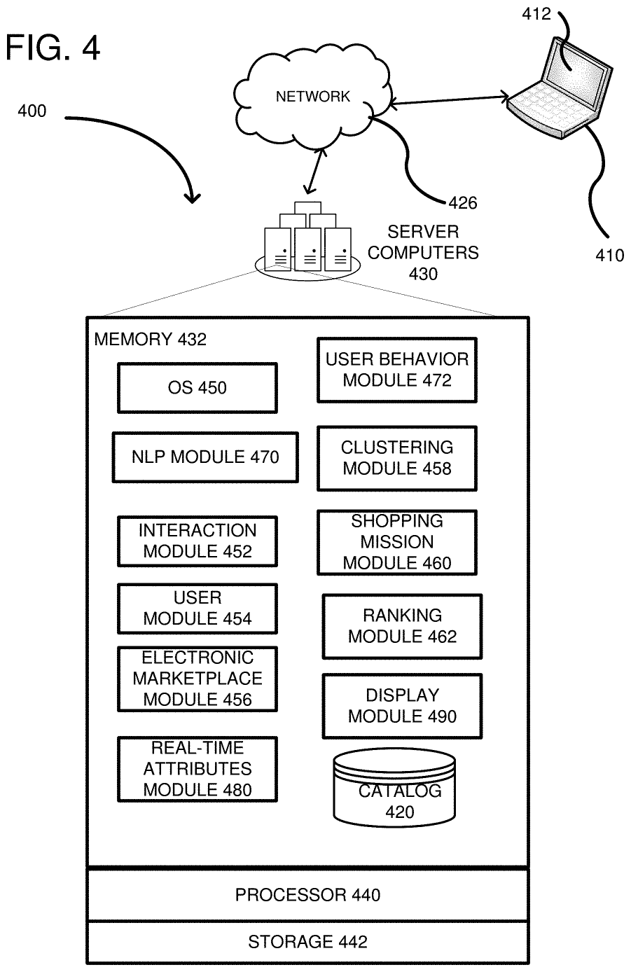

FIG. 4 illustrates a system 400 for associating one or more interactions with a cluster of interactions and user-selectable product options associated with the clusters. The system 400 allows one or more users to use computing devices, shown generally at 410, to use a browser (an application executing on the computer 410), which is shown generally at 412, to search a catalog 420 via one or more networks 426. The catalog 420 is provided by a marketplace provider, which includes one or more host server computers 430. The host server computers 430 associates one or more interactions with the cluster of interactions or a shopping mission, and provide content to one or more user devices 410 based on the associations.

The network 426 is any type and/or form of network and includes any of the following: a point-to-point network, a broadcast, local area or wide area network, a telecommunications or data communication network, a computer network, an ATM (Asynchronous Transfer Mode) network, a SDH (Synchronous Digital Hierarchy) network, a SONET (Synchronous Optical Network) network, a wireless network and a wired network. The network also includes a wireless link, such as a satellite band or an infrared channel. The topology of the network is a bus, star, or ring network topology.

The browser application 412 allows the client devices 410 to interact with the one of the server computers 430 within the marketplace provider to search the catalog 420. The application 412 provides access to any website that supports user interaction, including social networking sites, online retailers, informational sites, blog sites, search engine sites, news and entertainment sites, and the like. The client device 410 is any type of computing device such as, but not limited to, a mobile phone, a smart phone, a personal digital assistant (PDA), a laptop computer, a desktop computer, a thin-client device, a tablet PC, an electronic book (e-book) reader, etc.

In one illustrative configuration, the server computers 430 include at least one memory 432 and one or more processors 440. The processors 440 are implemented in hardware, computer-executable instructions, firmware, or combinations thereof. Computer-executable instruction or firmware implementations of the processor(s) 440 includes computer-executable or machine-executable instructions written in any suitable programming language to perform the various functions described.

The memory 432 stores program instructions that are loadable and executable on the processor(s) 440, as well as data generated during the execution of these programs. The memory 432 is volatile (such as RAM) and/or non-volatile (such as ROM, flash memory, etc.). Particular types of memory include SRAM, or DRAM. The server computers 430 include additional storage 442, which includes removable storage and/or non-removable storage. The additional storage 442 includes magnetic storage, optical disks, etc. The memory 432, the additional storage 442, both removable and non-removable, are all examples of computer-readable storage media. For example, computer-readable storage media includes volatile or non-volatile, removable or non-removable media implemented in any method or technology for storage of information such as computer-readable instructions, data structures, program modules, or other data. Additional types of computer storage media that are present in the server computers 430 include PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which is used to store the desired information and which is accessed by the server computers 430.

The memory 432 includes an operating system 450, the catalog 420 (which is located on one or more separate drives) and/or one or more application programs or services for implementing the features disclosed herein including one or more of an interaction module 452, a user module 454, electronic marketplace module 456, a clustering module 458, a shopping mission module 460, and/or a ranking module 462. The modules are software modules, hardware modules, or a combination thereof. If the modules are software modules, the modules are embodied as processor-executable instructions stored on a computer readable medium and processed by a processor in any of computer systems described herein. The interaction module 452 is programmed to determine or receive a history of interactions between a user and one or more network pages associated with an electronic marketplace. The history of interactions includes various information, including a time of an interaction, an item presented on at least one network page, an identification of the interaction performed, where a user clicked on a network page (e.g., using clickstream analysis, etc.), interactions performed by the user to view additional detail about an item or merchant, item information (e.g., description, title, image of an item, etc.), and the like. The interaction module 452 is also configured to determine a most recent event from the history of interactions based in part on the time of the interaction.

The user module 454 is programmed to determine data associated with a user or merchant that interacts with an electronic marketplace. This includes accessed network pages or items, name, location, items purchased or sold, and the like. The user module 454 is also configured to identify, update, or create a profile for a user that includes a user's state with respect to an identified shopping mission (e.g., complete/incomplete, low/high depth, etc.). The profile is used in part to determine which information about items are presented to the user through the electronic marketplace and/or is managed online.

The electronic marketplace module 456 is configured to enable one or more network pages for display. The network pages are configured to provide items, lists of items, search tools to find items, and tools to assist merchants in offering the items to users. The electronic marketplace includes a plurality of merchants that offer the item (e.g., the same item, different items, etc.) through the electronic marketplace.

The clustering module 458 is programmed to create or identify a cluster. The cluster includes one or more events associated with a user from the user's history of interactions. The cluster is limited to events that are of a same category as the most recent event, based in part on item attributes associated with the item presented on the at least one of the one or more network pages. The clustering module 458 also performs one or more of the following: associates one or more events with a cluster, associates an event with a cluster if the difference between the event and cluster is less than a threshold, instantiates a clustering process, or other performs other methods of associating an event with a cluster based in part on the similarities between the two.

The shopping mission module 460 analyzes an event associated with the cluster to form a mission associated with the cluster and whether the shopping mission is complete, ongoing, or incomplete (e.g., by looking at interactions associated with the shopping mission in chronological order, by determining whether the user will likely purchase an item associated with the shopping mission in the future using other users' interactions who participated in similar shopping missions in the past, etc.). The shopping mission module 460 determines content to provide to the user based at least in part on a state of the user with respect to the identified shopping mission, perform a hashing analysis, identify the shopping mission depth associated with the user, and determine a probabilistic model or predictive model (e.g., using a heuristic classification).

The ranking module 462 ranks shopping missions associated with the user. For example, a reminder is provided to the user for a particular shopping mission that is incomplete. To avoid annoying the user (or for other reasons), the shopping mission is ranked lower than other incomplete shopping missions. In some examples, the shopping mission associated with the notification corresponds with a higher decay value than other shopping missions, so that the ranking of the shopping mission is lower based in part on the decay value.

In some embodiments, a natural language processing (NLP) module 470 parses searches by a user and determine which part of the search terms are related to products in the catalog 420 and which terms are related to user-selectable product options that are positioned on detail pages of the product. For example, a search query of “running shoes, size 8” is parsed into “running shoes” and “size 8”. The term “running shoes” is searched for in the catalog 420 and determined to be a category of products. The term “size 8” is searched in the catalog and determined to be on the detail pages of products wherein the detail pages include product options that a user selects. Thus, a determination is made when parsing a search, which terms match catalog categories and which terms match product options.

The user behavior module 472 uses the results of the NLP module 470 as one of its inputs to determine product search behavior for a user. As described above, the “size 8” parameter indicates a user behavior that assists in pre-selecting product options when the products are redisplayed. The term “product options” is meant to indicate that a user wanting to purchase a product has to select one of multiple available options to complete the purchase. The user behavior module 472 uses various inputs based on past shopping behavior to make pre-selection determinations for the user from the available product options. Thus, past search queries parsed by the NLP module 470 are one input. Other inputs include click patterns of the user on like attributes. Thus, if the user repeatedly selects “size 8” from the product options, then that is a behavioral characteristic that is used in pre-selecting product options in the future. Past purchase behavior is another potential input. Thus, product options that a user has selected in completed purchases is used to determine user behavior. For example, if the user previously purchased running shoes and selected size 8, then the previous selection of like product options is an indicator of future selections. Still further, the user provides explicit preferences that should be pre-selected. For example, if the user always selects size 8, then the user enters their preferences for preselection to their account.

A real-time attributes module 480 obtains purchase-related attributes that changes frequently and provide updated information as to these attributes. As one example, shipping price and delivery scheduling (number of days) is obtained once a webpage is requested to be viewed and the real-time attributes is transmitted to a display module 490 that generates the display of a customized webpage for display on the client device 410. Other real-time attributes likewise be gathered and used for display. The real-time attributes are attributes that do not have user-selectable options.

Further details of modules within the memory 432 and details of clustering is found in U.S. Pat. No. 10,311,499, which is incorporated herein by reference.

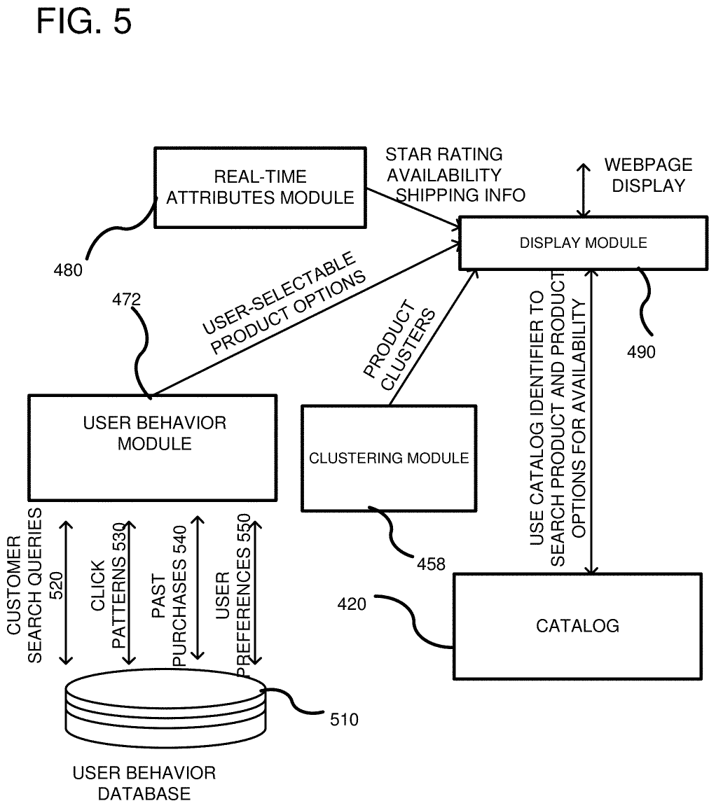

FIG. 5 shows further details of the interactions between the modules of FIG. 4. The user behavior module 472 stores and retrieves user data from a database 510, wherein the user data is associated with past searches, in order to interpret user behavior and determine likely current user-selectable product options based on past selected options. For example, past user search queries 520 are parsed to determine candidate user-selectable product options when terms in the search queries match one of the user-selectable options. Click patterns 530 are input into the user behavior module 472. The click patterns are associated with prior searches and how the user interacted with detail pages (sub-pages) associated with the product. In particular, if the user previously clicked on user-selectable options, such as where a user clicked on one of multiple potential options (e.g., size, shape, color, organic, model, etc.) associated with a single product, then such a click history is used to pre-select similar attributes associated with products being actively displayed. Past purchases 540 are related to how the user selected the user-selectable options in the past purchases. Such previous user-selected options are used to pre-select similar options for products currently being displayed. Finally, user preferences 550 are explicit preferences provided by the user that are stored in database 510. The user preferences 550 are chosen by the user so that pre-selection of similar options are accomplished for current products being displayed to the user. Using any one or a combination of these attributes 520, 530, 540, 550, the user behavior module 472 provides user-selectable product options to the display module 490 for consumption. The clustering module 458 is coupled to the display module 490 and provide identifiers of products for particular clusters. The identifiers are used by the display module 490 to retrieve products from the catalog 420. The display module 490 also uses inputs from the user behavior module 472 to pre-select product options for the user and check availability of such options. Finally, the display module 490 retrieves real-time attributes, such as shipping information, price, etc., from the real-time attributes module 480. The various inputs are used by the display module 490 to generate a webpage for display to a user. For example, if the user clicks on the “see more” UI element 230 of FIG. 2, the display module 490 makes a request to each of the modules 458, 472, 480 to obtain the necessary data to generate and display a webpage, such as is shown in FIG. 3.

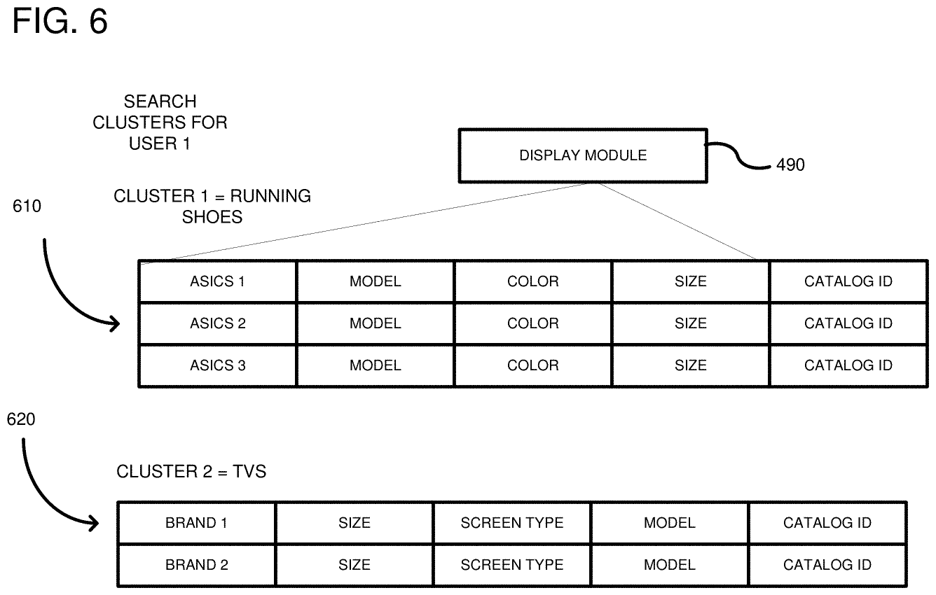

FIG. 6 illustrates an example of a data structure that is generated by the display module 490. A first cluster 610 relates to a first product and includes three different options from vendors. The illustrated fields within each row of the data structure include a brand field, a model number, a color previously chosen, a size previously chosen and a catalog identifier associated with the product. The model, color and size fields are used to pre-select product options for the user. For example, if the user previously purchased or clicked on red size 8 of the Asics, then those user-selectable product options are pre-selected for display to the user. Likewise, if the user's preferences are not available, such a fact is illustrated to the user, as is shown at 350 in FIG. 3. Thus, a user easily visualizes which vendors have the user's preferences available and which do not. At 620, a second cluster, unrelated to the first cluster, is generated. As illustrated in FIG. 2, two or more clusters are associated with different shopping missions, and each cluster is independent of the other cluster. Although two clusters are shown, additional clusters are added. Additionally, the user-selectable product options depend on the particular product and options needed to complete a purchase of the product. In the example of cluster 620, televisions have features such as model, size, screen type (LED, OLED, 4k, 8k) etc. Thus, different products have different user-selectable product options, and the webpages displayed are customized for the user depending on previous shopping missions, and the user's behavior in terms of the previous shopping.

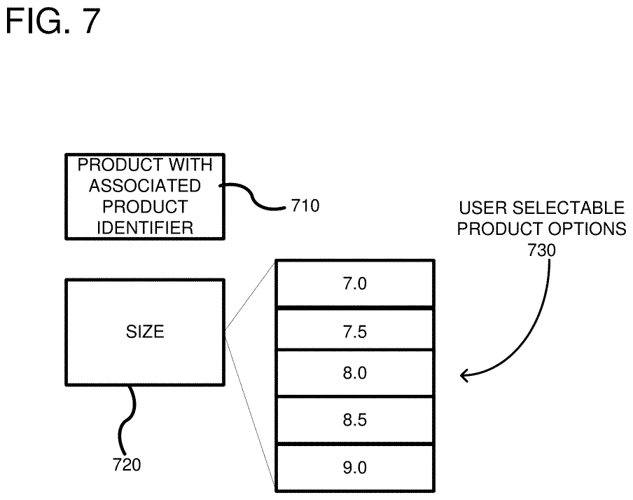

FIG. 7 shows an example of user selectable product options. To complete a purchase, a user visualizes a product 710 on a webpage, but to complete a purchase needs to select amongst various options. In the illustrated example, size 720 is one of the options. Typically, when a user selects a size option, a drop-down menu is displayed with a variety of options 730 from which the user chooses. The user generally selects one of the plurality of options. Previous selections made by the user in past shopping experiences are used to pre-select what the user is searching for in a new shopping mission. Thus, in FIG. 3, the size field 340 is pre-selected for the user based on which of the options 730 was previously selected.

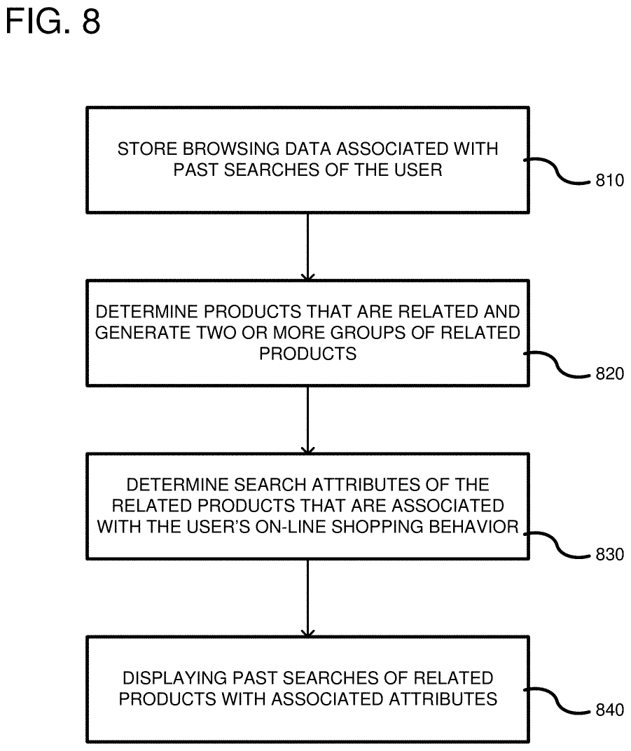

FIG. 8 is a flowchart of a method according to one embodiment. In process block 810, browsing data is stored that is associated with past searches of the user. As illustrated in FIG. 5, the past searches are related to search queries 520, clicked patterns 530, past purchases 540, or other information related to past searches. Together, the information associated with the past searches are considered browsing data of the user which is indicative of the user's on-line shopping behavior. In process block 820, products that are related are determined and groups of two or more related products are generated. For example, the clustering module 458 is used to generate groups of two or more products that are related. Related products have a same catalog identifier. Thus, a same make and model has a same catalog identifier, but the displayed product, even though identical, is sold by different vendors that offer different pricing and availability. FIG. 2 shows each group as a different mission (mission 1 and mission 2). Each mission includes a plurality of products previously searched upon and found in search results. In process block 830, search attributes of the related products are determined wherein the search attributes are associated with the user's on-line shopping behavior. The search attributes include the user's past search queries, clicked patterns and past purchases. Other search attributes can likewise be used. In process block 840, the past search results of related products are displayed in conjunction with the associated search attributes. For example, in FIG. 3, the past search results are shown at 320, 322 and, 324. The associated search attributes for product 320 are shown generally at 330 and include user selectable product options, such as size 340 and color 344.

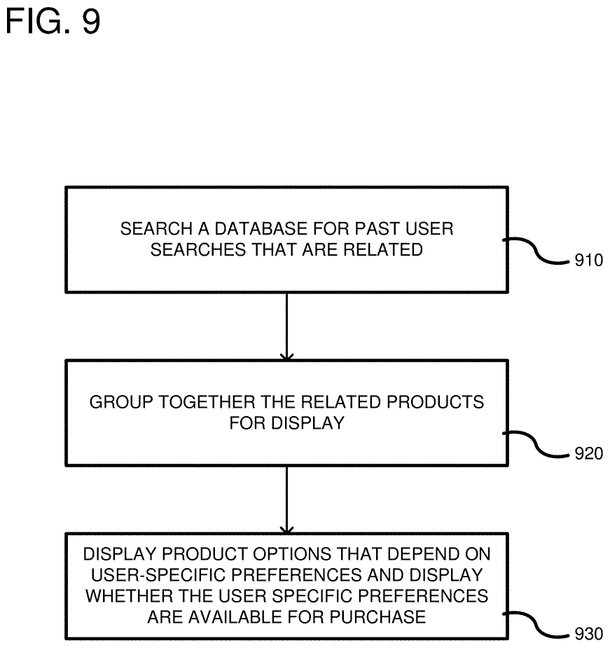

FIG. 9 is a flowchart of a method according to another embodiment. In process block 910 a data base is searched for past user searches that are related. For example, search results that have products within a same category of a catalog is considered related. In a simple example, all running shoes are within the same category. In process block 920 the related products are grouped together for display. For example, in FIG. 3, products 320, 322 and 324 are shown grouped together so that a user directly compares the products displayed. In process block 930, product options are displayed that depend on user specific preferences. Additionally, whether the user specific preferences are available for purchase are also displayed. For example, turning again to FIG. 3, the user specific preferences such as an inferred size 340 or inferred color 344 are displayed in association with the product 320. Additionally, as shown at 350, if a particular user specific preference is unavailable, then the display so indicates, in this case by putting a line through the user sign to show unavailability. Similarly, user size 340 does not have a line there through indicating that it is available.

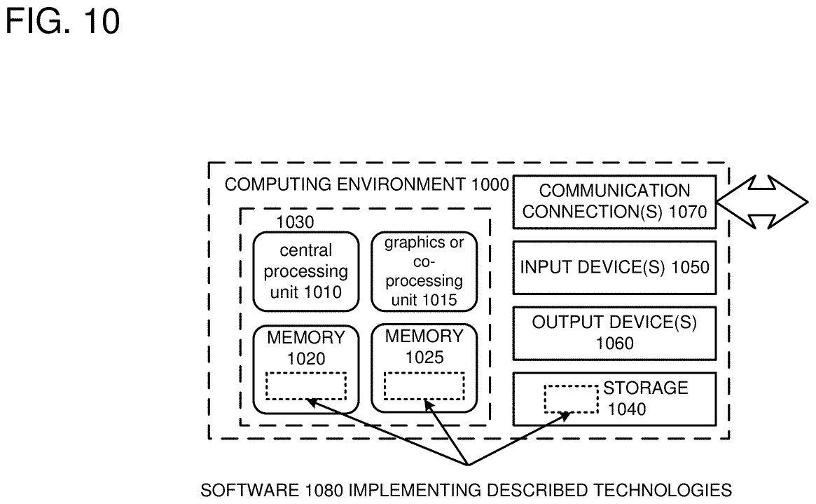

FIG. 10 depicts a generalized example of a suitable computing environment 1000 in which the described innovations are implemented. The computing environment 1000 is not intended to suggest any limitation as to scope of use or functionality, as the innovations are implemented in diverse general-purpose or special-purpose computing systems. For example, the computing environment 1000 is any of a variety of computing devices (e.g., desktop computer, laptop computer, server computer, tablet computer, etc.). The computing environment 1000 is used for one of the server computers 430 or the user device 410.

With reference to FIG. 10, the computing environment 1000 includes one or more processing units 1010, 1015 and memory 1020, 1025. In FIG. 10, this basic configuration 1030 is included within a dashed line. The processing units 1010, 1015 execute computer-executable instructions. A processing unit is a general-purpose central processing unit (CPU), processor in an application-specific integrated circuit (ASIC) or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 are be volatile memory (e.g., registers, cache, RAM), non-volatile memory (e.g., ROM, EEPROM, flash memory, etc.), or some combination of the two, accessible by the processing unit(s). The memory 1020, 1025 stores software 1080 implementing one or more innovations described herein, in the form of computer-executable instructions suitable for execution by the processing unit(s).

A computing system having additional features. For example, the computing environment 1000 includes storage 1040, one or more input devices 1050, one or more output devices 1060, and one or more communication connections 1070. An interconnection mechanism (not shown) such as a bus, controller, or network interconnects the components of the computing environment 1000. Typically, operating system software (not shown) provides an operating environment for other software executing in the computing environment 1000, and coordinates activities of the components of the computing environment 1000.

The tangible storage 1040 are be removable or non-removable, and includes magnetic disks, magnetic tapes or cassettes, CD-ROMs, DVDs, or any other medium which is used to store information in a non-transitory way and which is accessed within the computing environment 1000. The storage 1040 stores instructions for the software 1080 implementing one or more innovations described herein.

The input device(s) 1050 are be a touch input device such as a keyboard, mouse, pen, or trackball, a voice input device, a scanning device, or another device that provides input to the computing environment 1000. The output device(s) 1060 are be a display, printer, speaker, CD-writer, or another device that provides output from the computing environment 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media uses an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially are in some cases be rearranged or performed concurrently. Moreover, for the sake of simplicity, the attached figures are not show the various ways in which the disclosed methods are used in conjunction with other methods.

Any of the disclosed methods are implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments are stored on one or more computer-readable storage media. The computer-executable instructions are part of, for example, a dedicated software application or a software application that is accessed or downloaded via a web browser or other software application (such as a remote computing application). Such software is executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology are implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein is performed, at least in part, by one or more hardware logic components, instead of software. For example, and without limitation, illustrative types of hardware logic components that are used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) are uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

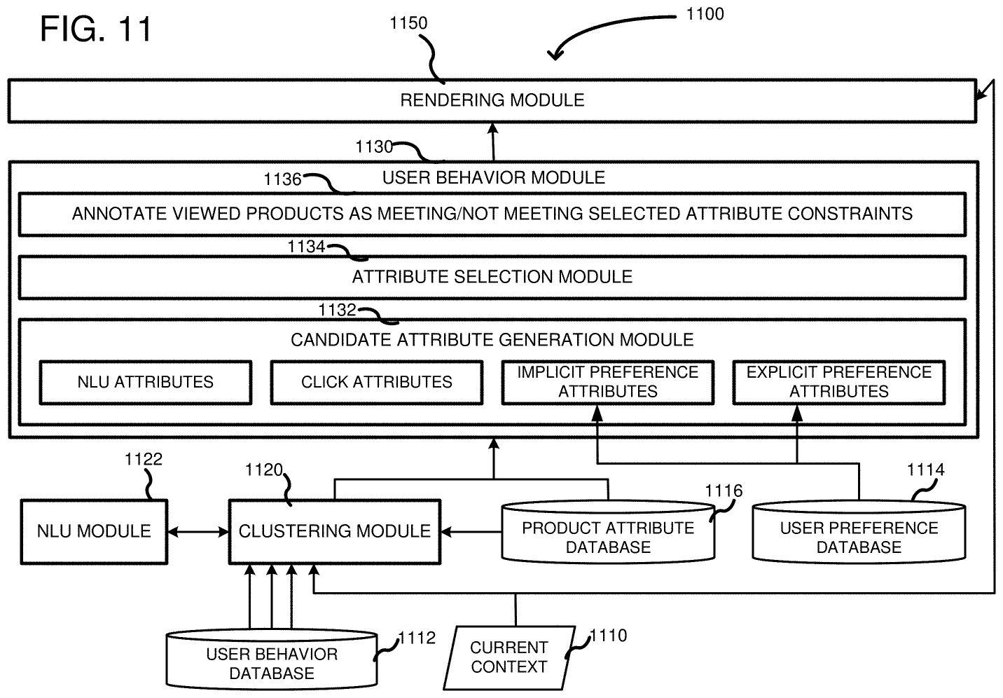

FIG. 11 shows another embodiment of a system 1100 for displaying a user on-line shopping mission. There are a number of inputs including a current context 1110, a user behavior database 1112, a user preference database 1114, and a product attribute database 1116. The current context (e.g., current search, current detail page, current cart ad, current purchase, etc.) is sent to the service at request time. The user behavior database stores search queries, purchases, clicks, etc. that are gathered at request time. User behaviors stored in the database 1112 include an event type (e.g., search query, purchase), an event identifier (e.g., “productId=123”, “query=dress”), and a timestamp indicating when the behavior occurred. The user preference database 1114 is keyed by the user (primary) and product category (secondary). Some examples include “user=123”→(productCategory=RUNNING SHOES→(brandPreference=ASICS, type=IMPLICIT), (sizePreference=10, type=IMPLICIT), (department=MENS, type=IMPLICIT)), (productCategory=DRESS SHIRTS→(brandPreference=BANANA_REPUBLIC, type=IMPLICIT), (sizePreference=M, type=EXPLICIT), (department=MENS, type=EXPLICIT)). These attributes are typically implicit (learned from user behaviors), or explicitly indicated by the user. The product attributes database 1116 is keyed by the product (e.g., “productld=123”→“brand=ASICS”, “size=10”, . . . ).

Clustering features are gathered for current context in the clustering module 1120. These features include the following: co-viewed products (based on aggregate user behavior) for purchased and clicked items; clicked products (based on aggregate user behavior) for search queries; searches (based on aggregate user behavior) which lead to purchased and clicked items; co-searched searches (based on aggregate user behavior) for searches; product attributes for purchased and clicked items; product attributes for products subsequently interacted with for search queries (based on aggregate user behavior); product attributes based on natural language understanding using the natural language understanding module 1122, which maps queries to product attributes (e.g., “red dress”=>(attributeType:color, attributeValue:RED[id=1234]), (attributeType:productCategory, attributeValue:DRESS[id=2345])).

These features serve as a means to cluster user behaviors. Given a feature vector for each user behavior (comprised of features described above), a similarity metric is constructed between any two user behaviors. The similarity metric is unsupervised or supervised (i.e., a similarity metric learned based on training data). An algorithm clusters behaviors based on the similarity metric between items. The output includes a clustering N clusters of M user behaviors (typically, M is much less than N). Each cluster represents a distinct shopping mission, which roughly corresponds to shopping for a particular type of product (e.g., “television”, “dress”, “men's dress shirt”, etc.). To identify the most relevant mission for the current context, the current context is included in the clustering; the cluster in which the current user behavior (e.g., search query, click, purchase, cart add, etc.) is placed is identified as the “current mission”.

The product attribute selection relates to user intent identification and performs the following functions. Given N clusters, attributes are identified that are important to a user for a particular mission. For a given cluster, candidate attributes are identified through the following methods:

1) for search queries in the cluster, natural language understanding is used to understand what attributes the user has specified in their query;

2) given the productCategory identified for the mission (the clusters are of productCategories), user preferences are identified for that category using the user preference database. These preferences are implicit or explicit.

3) given a number of user events (e.g., clicks) for the mission, along with a product attribute database, common attributes can be identified amongst the clicked items (e.g., brand, size, color, etc.)

Given these candidate attributes, the attributes can be selected which are most representative of the user's mission through one or more of the following methods performed in an attribute selection module 1134:

1) Select the types of attributes based on their importance in purchasing a product. The types are selected based on aggregate behavior (for instance, for apparel, size and brand are selected), with personalized attribute types selected based on what the user has expressed through their searches. For example, a search for a “red dress under $50” would mean “price” is type of attribute which is selected.

2) Define constraints on the attribute type based on all information about the user. For instance, for a given type of attribute (e.g., size), identify if the user has specified a constraint through their behaviors. For example, the user might have searched for “running shoes size 10” or an implicit preference is identified based on previous purchases (the user has purchased 5 pairs of size 10 shoes). For a given type of attribute, a constraint (for example, size=10 or price <=$50) is indicated. In cases where there are conflicts between indicated constraints (for example, user has a history of purchasing size 11 shoes but searches for “running shoes size 10”), a conflict resolution algorithm is specified to select the appropriate constraint for the context. Two example methods include the following:
a. a rule-based prioritization scheme for selecting constraints, such as use explicit preferences, unless there is a more recent implicit preferences which conflict or more recent NLU which conflicts or more recent clicking behavior which conflicts. Use implicit preferences, unless there is more recent NLU which conflicts or more recent clicking behavior which conflicts. Use NLU, unless there is more recent clicking behavior which conflicts.
b. A machine-learned method scheme for selecting constraints which learns, for each attribute type and given N candidate constraints, predicts the constraint which is most likely predictive of user behavior. This might be accomplished through a supervised learning algorithm (e.g., a Deep Neural Network), which is trained using cluster information as context, the candidate attribute constraint as an independent variable, and then the target being whether the user made a purchase that met the constraint or not. The learning method uses a standard feedforward neural network, or a more sophisticated network such as a transformer network (which learns to attend to particular aspects of the cluster history to make the prediction).

In a module 1136, given the selected types of attributes and the constraints for each type of attribute, each product in the cluster can be evaluated as to whether it meets the constraints for that type. Constraints can be evaluated by looking up a products attribute values in the product attribute database.

To limit online latency, computation is restricted to the mission which is clustered to the current context. Product attributes selected for other missions are retrieved from an online cache. After updating of the current mission, the mission with selected attributes is cached. Updates of missions and selected attributes occur if there are subsequent user behaviors clustered to the mission.

Given N clusters, each with (a) selected attribute constraints and (b) identification of whether each product meets those constraints, the clusters are displayed to users. Each cluster is identified by the product category of the cluster. For each product in the cluster, the attributes for that product are identified as meeting or not meeting the desired user intent. Since the current context has also been clustered, the rendering system 1150 is elected to display only the cluster of products which is relevant to the current context.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention are be applied, it should be recognized that the illustrated embodiments are only examples of the invention and should not be taken as limiting the scope of the invention. We therefore claim as our invention all that comes within the scope of these claims.

What is claimed is:

1. A method of displaying a user on-line shopping mission, the method comprising:
storing browsing data associated with past search results of the user, the browsing data including products searched by the user;
determining products that are related from the stored browsing data and generating two or more different groups of related products, wherein each group is a separate mission including two or more related products;
receiving user input selecting one of the two or more groups;
determining search attributes of the related products for the selected group, the search attributes associated with the user's past on-line shopping behavior including user-selectable product options related to the products; and
displaying the selected group of the related products and the determined search attributes displayed therewith so as to display the past search results and the user's on-line shopping behavior including the user-selectable product options associated with the past search results.

2. The method of claim 1, further including determining real-time attributes associated with the related products in the selected group and displaying the real-time attributes in association with the determined search attributes.

3. The method of claim 2, wherein the user-selectable product options include sizing information and the real-time attributes include shipping costs.

4. The method of claim 1, wherein the user's online shopping behavior includes user search queries, click patterns on like attributes, past purchase behavior, and explicit preferences supplied by the user.

5. The method of claim 1, wherein the determining that the products are related includes determining that the products are associated with a same catalog identifier.

6. A user interface, comprising:
a first panel for displaying a browser search engine interface for a user to enter search engine queries, the first panel having a User Interface (UI) element; and
a second panel associated with the first panel, the second panel for being displayed when the UI element is selected, the second panel for displaying at least one group of two or more related products previously searched by the user for direct comparison of the two or more related products and for displaying user-selectable product options in association with the two or more related products, wherein the user-selectable product options depend upon the user's past online shopping behavior.

7. The user interface of claim 6, wherein the past on-line shopping behavior includes click history associated with the user-selectable product options.

8. The user interface of claim 7, wherein the user-selectable product options include size information or color information previously selected by the user in past on-line shopping.

9. The user interface of claim 6, further including a natural language processing module for implementing natural language processing on past searches to determine which user-selectable product options are displayed.

10. The user interface of claim 6, wherein the user-selectable product options that are displayed change based on past user browsing behavior, including past purchases by the user and which user-selectable product options were selected by the user on the past purchases.

11. The user interface of claim 6, wherein one of the user-selectable product options displayed includes a size associated with the products and the size is obtained from past purchases.

12. The user interface of claim 12, wherein the products are displayed with an indicator of whether the size is available.

13. The user interface of claim 6, wherein the groups of related products are based on whether the products have a matching catalog identifier.

14. The user interface of claim 6, wherein the second panel is further for displaying real-time modifiable purchase attributes associated with the products.

15. A computer-implemented method, comprising:
searching a database of past user searches for products that are related;
grouping together the related products for display to the user; and
for any group, displaying product options that depend on user-specific preferences in association with the related products, and displaying whether the user-specific preferences for the product options are available for purchase, wherein the user-specific preferences are based upon a past browsing history of the user.

16. The computer-implemented method of claim 15, further including calculating real-time features associated with purchasing the product and displaying the real-time features in association with the product.

17. The computer-implemented method of claim 16, wherein the real-time features include a shipping cost.

18. The computer-implemented method of claim 15, wherein the user-specific preferences include sizing information and wherein the sizing information is determined based on past purchases of products in a same category.

19. The computer-implemented method of claim 15, wherein products in one of the groups is unrelated to products in another of the groups and the products are in a same group if they have a same catalog identifier.

20. The computer-implemented method of claim 15, wherein the past browsing history includes past purchases, past click behavior, and past search queries.
